(19) United States
(12) Patent Application Publication
(10) Pub. No.: US 2026/0197097 A1
(43) Pub. Date: Jul. 9, 2026

(54) METHOD AND SYSTEM FOR DETERMINING AN OPERATING FREQUENCY OF AN ACOUSTIC TRANSMISSION SYSTEM

(71) Applicant: COMMISSARIAT À L'ENERGIE ATOMIQUE ET AUX ENERGIES ALTERNATIVES, PARIS (FR)

(72) Inventors: Nicolas GARRAUD, GRENOBLE (FR); Esteban CABANILLAS, Grenoble (FR)

(21) Appl. No.: 19/425,763

(22) Filed: Dec. 18, 2025

(30) Foreign Application Priority Data
Dec. 20, 2024 (FR) 2415005

(51) Int. Cl. H04B 17/10; H02J 50/15; H02J 50/80; H04B 11/00; H04B 17/11; H04B 17/20

(52) U.S. Cl. CPC H04B 17/104; H02J 50/15; H02J 50/80; H04B 11/00; H04B 17/11; H04B 17/255

(57) ABSTRACT

A method for determining an operating frequency of an acoustic transmission system includes a primary element and a secondary element arranged on either side of a wall, the primary element including a first electro-acoustic transducer for generating and detecting acoustic waves, the secondary element including a second electro-acoustic transducer and being configured to controllably change an electrical impedance across the terminals of the second transducer between an open-circuit state and a short-circuit state; wherein the operating frequency is determined from the change as a function of the frequency of the phase difference between an input impedance, on the primary element side, of an electric quadrupole modelling the assembly formed by the first and second acoustically coupled transducers, with the second transducer in a short circuit and in an open circuit. A system for carrying out such a method is also provided.

### CROSS-REFERENCE TO RELATED APPLICATION

This application claims priority to foreign French patent application No. FR 2415005, filed on Dec. 20, 2024, the disclosure of which is incorporated by reference in its entirety.

### FIELD OF THE INVENTION

The invention relates to the field of acoustic power and data transmission (APDT) systems.

### BACKGROUND

Such systems make it possible to achieve communication—generally over a short distance, that is to say over distances of the order of centimetres or at most metres—between devices located on either side of a wall, particularly made of metal. The communicating devices may be, for example, on the one hand, one or more sensors and, on the other hand, a station for controlling said sensors.

The use of radiofrequency or microwave communication techniques—for example RFID, Bluetooth, WiFi—is not possible because the metal wall absorbs electromagnetic waves. For the same reasons, it is not possible to use electromagnetic induction to power the sensors. Furthermore, the use of wire-based techniques would require drilling holes in the wall, this possibly posing problems with regard to cost, structural integrity and sealing.

Under these conditions, it is known to use acoustic waves to transmit power and/or data through the wall.

For example, a primary element (control station) located on an accessible side of a wall, such as the outside of a pipe, may emit acoustic waves towards a secondary element (sensor) located on an inaccessible side of said wall, such as the inside of the pipe. On the sensor side, an electro-acoustic, typically piezoelectric, transducer converts the energy of the acoustic waves into an electric current which may be used to directly power electronic circuits and/or to charge a battery or a supercapacitor. Moreover, the acoustic waves emitted by the primary element may be modulated to transmit data to the secondary element, for example configuration or interrogation data of the sensor. The sensor may also transmit data, for example measurement data, to the control station either by emitting acoustic waves in turn, or by modulating the phase of the acoustic waves coming from the control station and reflected towards it. In the latter case, this phase modulation may be achieved simply by modifying the impedance across the terminals of the electro-acoustic transducer; this is then referred to as communication by impedance modulation or switching. See for example (Takahashi 2019).

The power transmission varies greatly with the frequency of the acoustic waves due to resonance effects in the wall. This is illustrated in [FIG. 1] which shows the variation in the energy transmission efficiency η (in percentage), the normalized maximum power transmitted (\tilde{P}₂) and the normalized maximum voltage \tilde{V}₂ generated by the receiving transducer as a function of frequency. The power is normalized in relation to the square of the input voltage, and the output voltage is normalized in relation to the input voltage V₁. For each frequency, an impedance of optimal value across the terminals of the transducer has been considered.

However, these resonant frequencies vary depending on temperature, changes in geometry, etc. The operating frequency of the system cannot therefore be determined once and for all but must be determined regularly and in a way that is as simple as possible.

Document EP 4 080 791 discloses a method for determining the frequency which maximizes the transfer of power from the primary element to the secondary element. In accordance with this method, three frequency sweeps of the acoustic waves are performed for three different values of an impedance across the terminals of the electro-acoustic transducer of the secondary element. This makes it possible to evaluate the impedance matrix of the quadrupole formed by the wall and the two transducers, and to deduce the desired frequency therefrom.

Document EP 3 671 872 proposes choosing the frequency for which the phase of the input admittance is minimum, with the transducer of the secondary element in an open circuit. This does not guarantee that maximum efficiency or transmitted power is achieved, nor does it make it possible to determine the electrical load to be connected.

Document EP 2 832 016 proposes choosing the frequency which makes it possible to maximize the voltage across the terminals of a storage capacitor of the secondary element. This requires communication to have been established beforehand so that the secondary element can transmit information regarding the charge level of the capacitor to the primary element.

Document US2010/0027379 describes an operation in which the operating frequency is determined by maximizing the amplitude of the received signal, this also requiring communication between the secondary element and the primary element to have been established beforehand.

Document U.S. Pat. No. 10,559,981 discloses an operation in which the operating frequency is determined by identifying a local minimum of the phase of the impedance. More particularly, the operating frequency corresponds to the local minimum closest to a predefined “overall optimal frequency”.

The known methods of the prior art are not entirely satisfactory. Specifically, the present inventors have realized that said methods do not make it possible in all cases to ensure optimal operation of the transmission system, that is to say operation guaranteeing at the same time:
a sufficiently high power level from the primary element to the secondary;
a high efficiency—defined as the ratio between the power received by the secondary element and the power consumed by the primary element;
a sufficiently high voltage across the terminals of the transducer of the secondary element, in particular with respect to the threshold voltages of diodes connected to said transducer; and
a high communication rate.

Moreover, some of the methods of the prior art are complex to carry out (for example, the method of EP 4 080 791 uses three frequency ramps and three impedance values across the terminals of the secondary) and/or require communication between the secondary element and the primary element to have been established beforehand (this is in particular the case for US2010/0027379). This may be problematic when the energy storage device (battery or supercapacitor) of the secondary element is fully discharged, it is then necessary to carry out a preliminary step of charging this storage device but “blindly”, without knowing the optimal operating frequency.

### SUMMARY OF THE INVENTION

The invention aims to overcome, in whole or in part, these limitations of the prior art.

In accordance with the invention, this objective is achieved by determining the operating frequency as a function of the difference Δφ between the phase of the input impedance of an electric quadrupole modelling the assembly formed by the transducers of the primary and secondary acoustically coupled elements when the transducer of the secondary element is in a short circuit, and the phase of said input impedance when the transducer of the secondary element is in an open circuit.

More particularly, the operating frequency may be the frequency which maximizes Δφ. This frequency is optimal for communication by impedance modulation, and makes it possible to achieve the highest throughput. In addition, the present inventors have realized that it is almost optimal in terms of transmitted power and efficiency.

As a variant, it is possible to choose a higher frequency, but one that is lower than the value for which Δφ=0. Such a choice makes it possible to improve the transmitted power and the output voltage, but at the cost of a worsened throughput. The optimal compromise will depend on the particular application in question, but generally the communication rate will be favoured by choosing an operating frequency which ensures a phase difference Δφ at least equal to half its maximum value.

One object of the invention is therefore a method for determining an operating frequency of an acoustic transmission system comprising a primary element and a secondary element, the primary element comprising a first electro-acoustic transducer configured to generate acoustic waves of variable frequency in the direction of the secondary element through a wall and to detect reflections of said acoustic waves by the secondary element, the secondary element comprising a second electro-acoustic transducer designed to convert said acoustic waves into an electric supply current, said secondary element being further configured to controllably change an electrical impedance across the terminals of said second transducer between an open-circuit state and a short-circuit state; characterized in that it comprises the following steps:
a) emission of said acoustic waves from the primary element to the secondary element, while keeping the second transducer in a short circuit;
b) simultaneously with step a), measurement of a first phase of the input impedance, on the primary element side, of an electric quadrupole modelling the assembly formed by the first and second acoustically coupled transducers, with the second transducer in a short circuit;
c) emission of said acoustic waves from the primary element to the secondary element, while keeping the second transducer in an open circuit;
d) simultaneously with step c), measurement of a second phase of the input impedance, on the primary element side, of an electric quadrupole modelling the assembly formed by the first and second acoustically coupled transducers, with the second transducer in an open circuit;
e) calculation of the difference Δφ between the first and second phases;
said steps a) to e) being repeated for a plurality of frequencies sweeping an operating range of the acoustic transmission system; and then
f) determination of said operating frequency as a function of said difference between the first and second phases calculated for said plurality of frequencies.

According to particular embodiments of this method:

The operating frequency determined in step f) may be between a first value f₁ maximizing said difference between the first and second phases and a second value f₂ cancelling it, the latter value being excluded.

More particularly, the operating frequency determined in step f) may be between said first value maximizing said difference between the first and second phases and a third value f₃ between said first and second values and such that said difference between the first and second phases assumes a value no less than half its maximum value.

The method may comprise, in the secondary element, the actuation of a switching device to change from a state in which the second transducer is in a short circuit to a state in which the second transducer is in an open circuit and vice versa.

As a variant, the secondary element may comprise a pair of diodes connected head-to-tail in parallel with said second transducer, the method comprising the emission, by said primary element, at successive instants, of said acoustic waves at a first intensity level sufficiently low that a voltage generated by said second transducer excited by said acoustic waves is lower than a voltage of only said diodes, and at a second intensity level sufficiently high that a voltage generated by said second transducer excited by said acoustic waves is greater than a voltage of only said diodes.

Steps a) to e) may be carried out successively for each frequency of said plurality of frequencies.

As a variant, steps a) and b) may first be carried out for said plurality of frequencies, then steps c) and d) may in turn be carried out for the same frequencies, or vice versa.

Another object of the invention is an acoustic transmission system comprising a primary element and a secondary element, the primary element comprising a first electro-acoustic transducer configured to generate acoustic waves of variable frequency in the direction of the secondary element through a wall and to detect reflections of said acoustic waves by the secondary element, the secondary element comprising a second electro-acoustic transducer designed to convert said acoustic waves into an electric supply current, said secondary element being further configured to controllably change an electrical impedance across the terminals of said second transducer between an open-circuit state and a short-circuit state; characterized in that the transmission system comprises a first control means configured to control the primary element so as to, for a plurality of frequencies sweeping an operating range of the acoustic transmission system:
a) emit said acoustic waves from the primary element to the secondary element, while keeping the second transducer in a short circuit;
b) simultaneously with step a), measure a first phase of the input impedance, on the primary element side, of an electric quadrupole modelling the assembly formed by the first and second acoustically coupled transducers, with the second transducer in a short circuit;
c) emit said acoustic waves from the primary element to the secondary element, while keeping the second transducer in an open circuit;
d) simultaneously with step c), measure a second phase of the input impedance, on the primary element side, of an electric quadrupole modelling the assembly formed by the first and second acoustically coupled transducers, with the second transducer in an open circuit;
the control means also being configured to
e) calculate the difference Δφ between the first and second phases for each frequency of said plurality of frequencies; and to
f) determine said operating frequency as a function of said difference between the first and second phases calculated for said plurality of frequencies.

According to particular embodiments of this system:

Said control means may be configured to determine a said operating frequency between a first value f₁ maximizing said difference between the first and second phases and a second value f₂ cancelling it, the latter value being excluded.

More particularly, said control means may be configured to determine a said operating frequency between said first value maximizing said difference between the first and second phases and a third value f₃ between said first and second values and such that said difference between the first and second phases assumes a value no less than half its maximum value.

The system may comprise, in the secondary element, a second control means as well as a switching device, said second control means being configured to control the actuation of said switching device so as to cause it to change from a state in which the second transducer is in a short circuit to a state in which the second transducer is in an open circuit and vice versa.

As a variant, the secondary element may comprise a pair of diodes connected head-to-tail in parallel with said second transducer, said first control means also being configured to control the first transducer so that it emits, at successive instants, said acoustic waves at a first intensity level sufficiently low that a voltage generated by said second transducer excited by said acoustic waves is lower than a voltage of only said diodes, and at a second intensity level sufficiently high that a voltage generated by said second transducer excited by said acoustic waves is greater than a voltage of only said diodes.

Said first control means, or said first and second control means, may be configured to carry out steps a) to e) successively for each frequency of said plurality of frequencies.

As a variant, said first control means, or said first and second control means, may be configured to first carry out steps a) and b) for said plurality of frequencies, then steps c) and d) for the same frequencies, or vice versa.

### BRIEF DESCRIPTION OF THE DRAWINGS

Other features, details and advantages of the invention will become apparent on reading the description given with reference to the appended drawings, which are given by way of example, and which show, respectively:

FIG. 1, already mentioned above, a graph of the variation in the energy transmission efficiency, the maximum power transmitted and the maximum voltage generated by a receiving transducer as a function of the frequency of an acoustic wave transmitted through a wall;

FIG. 2, the block diagram of an acoustic power and data transmission system which may be suitable for carrying out the invention;

FIG. 3, graphs illustrating the principle on which the invention is based;

FIG. 4, a flowchart of a method for determining an operating frequency according to one embodiment of the invention;

FIG. 5, a flowchart of a method for determining an operating frequency according to another embodiment of the invention;

FIG. 6, the block diagram of a primary element of an acoustic power and data transmission system according to one embodiment of the invention;

FIG. 7, the block diagram of a secondary element of an acoustic power and data transmission system according to one embodiment of the invention; and

FIG. 8, the block diagram of a primary element of an acoustic power and data transmission system according to another embodiment of the invention.

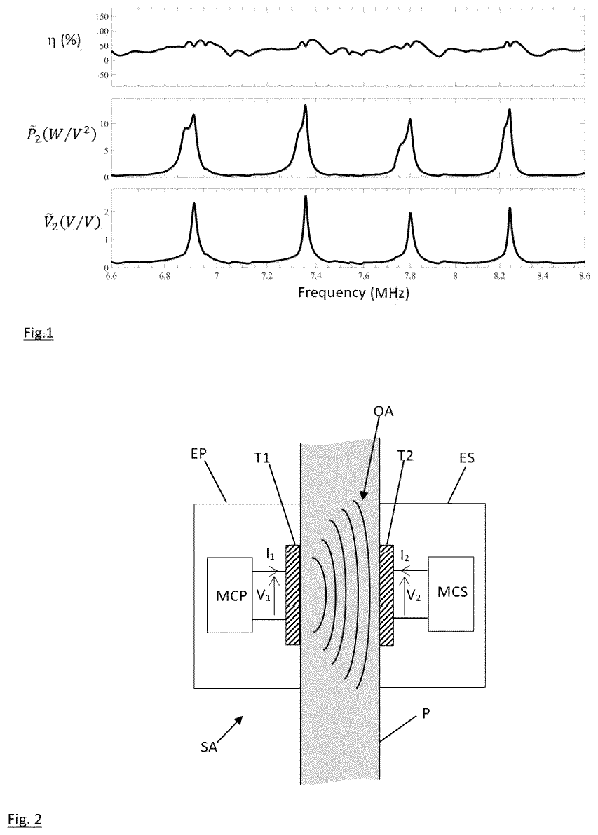

### DETAILED DESCRIPTION

The acoustic power and data transmission system SA of FIG. 2 comprises a primary element EP and a secondary element ES arranged on either side of a wall P, for example made of metal. The primary element EP comprises a first electro-acoustic (typically piezoelectric) transducer T1 and a first control means—consisting of one or more electronic circuits—MCP electrically connected to the first electro-acoustic transducer T1. Similarly, the secondary element ES comprises a second electro-acoustic (typically piezoelectric) transducer T2 and a second control means—consisting of one or more electronic circuits—MCS electrically connected to the second electro-acoustic transducer T2. The first electro-acoustic transducer T1 is used both to emit and to receive: it is supplied with alternating electric current by the first control means MCP to generate acoustic waves OA which propagate through the wall P. The acoustic waves OA are partially reflected and partially absorbed by the second transducer T2.

The acoustic power absorbed by the second transducer T2 is converted into electrical power which is used directly to power the second control means MCS and/or to charge a supply battery or supercapacitor (not shown).

The reflected fraction of the acoustic waves OA passes through the wall P again and influences the voltage V₁ across the terminals of the transducer T1 and/or the current I₁ which passes through it. This voltage and this current are read by the first control means MCP.

The (complex) coefficient of reflection of the acoustic waves by the second transducer T2 depends, among other things, on the electrical impedance connected to its terminals, the value of which may be varied by the second control means MCS. Thus, the first control means MCP, by analysing the phase and the amplitude of the voltage V₁ and of the current I₁, can detect a change in said impedance. This effect is exploited to transmit information from the secondary element ES to the primary element EP. Typically, this transmission is done in a binary manner, the impedance across the terminals of the second transducer T2 switching between a high value, in principle infinite—in which case the transducer may be considered to be in an open circuit—and a low value, in principle zero, in which case the transducer may be considered to be in a short circuit. As a variant, it is possible to switch between an impedance which is “high” but not infinite and an impedance which is “low” but does not constitute a short circuit. This allows the secondary element to communicate while recovering energy from the acoustic waves. It is also possible to use more than two impedance values.

The assembly made up of the two transducers T1, T2 acoustically coupled through the wall P can be modelled by an electric quadrupole. Let V₁ be the voltage across the terminals of the transducer T₁ and I₁ be the current entering said transducer; similarly, let V₂ be the voltage across the terminals of the transducer T2 and 12 be the current entering said transducer. This can then be written as:

$$( \begin{matrix}{V}_{1} \\ {V}_{2}\end{matrix} ) = ( \begin{matrix}{Z}_{11} & {Z}_{12} \\ {Z}_{21} & {Z}_{22}\end{matrix} ) ( \begin{matrix}{I}_{1} \\ {I}_{2}\end{matrix} )$$

Where Z₁₁, Z₁₂=Z₂₁ and Z₂₂ are complex values having the dimensions of an impedance.

When the transducer T2 is in an open circuit, I₂=0; consequently

$${V}_{1} = {V}_{1}^{oc} = {Z}_{11} {I}_{1}^{oc} and {V}_{2} = {V}_{2}^{oc} = {Z}_{12} {I}_{1}^{oc}$$

(where the superscript “oc” means “open circuit”). It is deduced therefrom that:

$${Z}_{11} = \frac{{V}_{1}^{oc}}{{I}_{1}^{oc}} ,$$

$${Z}_{12} = \frac{{V}_{2}^{oc}}{{I}_{1}^{oc}}$$

When the transducer T2 is in a short circuit,

$${V}_{2} = {V}_{2}^{sc} = 0 ;$$

consequently

$${V}_{1} = {V}_{1}^{sc} = {Z}_{11} {I}_{1}^{sc} ( 1 - {c}^{2} ) ,$$

and consequently

$${Z}_{11} = \frac{{V}_{1}^{sc}}{{I}_{1}^{sc} ( 1 - {c}^{2} )}$$

where the superscript “sc” means “short circuit” and the coupling parameter c is given by

$$C = \frac{{Z}_{12}}{\sqrt{{Z}_{11} {Z}_{12}}} .$$

The input impedance is defined

$${Z}_{in} = \frac{{V}_{1}}{{I}_{1}} ,$$

which can be determined exclusively from measurements made by the first control means MCP. When T2 is in an open circuit,

$${Z}_{in}^{oc} = {Z}_{11} ,$$

and when T2 is in a short circuit

$${Z}_{in}^{sc} = {Z}_{11} ( 1 - {c}^{2} ) .$$

The variation in the input impedance of the quadrupole when T2 changes from being in an open circuit to being in a short circuit is therefore

$$Δ \vert {Z}_{in} \vert = \vert {Z}_{in}^{sc} \vert - \vert {Z}_{in}^{oc} \vert = \vert \frac{{Z}_{12}^{2}}{{Z}_{22}} \vert$$

in modulus and

$$Δφ = arg ( {Z}_{in}^{sc} ) - arg ( {Z}_{in}^{oc} )$$

in phase.

In practice, in order to extract the information encoded in the impedance switchovers across the terminals of the transducer T2, the first control means preferably detects that the phase of the input impedance variation Δφ, the measurement of which is less sensitive to noise than that of the modulus Δ|Zᵢₙ|, is high; the higher the signal-to-noise deviation of the communication channel from ES to EP, the higher the transmission rate.

These various impedances, and therefore also Δφ, are generally a function of the excitation frequency f of the transducer T1 (and therefore of the acoustic waves OA).

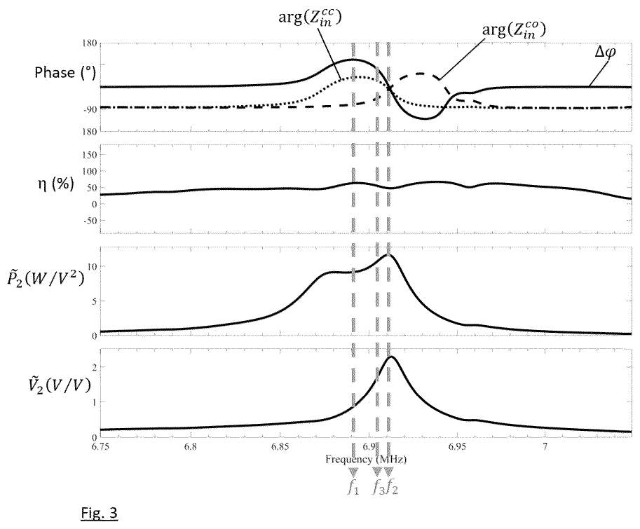

FIG. 3 shows how

$$arg ( {Z}_{in}^{sc} ) , arg ( {Z}_{in}^{oc} ) , a , Δφ = ( top panel ) ,$$

the power transmission efficiency η (2^{nd} panel from the top), the normalized maximum power transmitted \tilde{P}₂ (3^{rd} panel from the top) and the normalized maximum voltage \tilde{V}₂ generated by the receiving transducer (bottom panel) change as a function of the frequency fin an acoustic power and data transmission system SA. The curves in [FIG. 3] vary to some extent depending on the implementation details of the system SA but their appearance remains remarkably constant. The conclusions that can be drawn therefrom are therefore general in scope.

It should be noted that the frequency f₁ which maximizes Δφ makes it possible to achieve an efficiency η and a transmitted power \tilde{P}₂ close to their respective maxima. This is therefore a beneficial operating point for the system SA. When increasing the operating frequency beyond f₁, Δφ decreases—first slowly, then more rapidly, while \tilde{P}₂ increases slightly and \tilde{V}₂ increases more significantly. For f=f₂, \tilde{P}₂ and \tilde{V}₂ are maximized but communication is impossible because Δφ=0. Advantageously, therefore, an operating frequency equal to f₁ (to maximize the transmission rate) or between f₁ and f₂ (the latter value being excluded) and preferentially between f₁ and f₃, such as

$$Δφ ( {f}_{3} ) = \frac{1}{2} Δφ ( {f}_{1} )$$

(to find a compromise between the maximization of Δφ and that of \tilde{P}₂ and \tilde{V}₂) will be chosen.

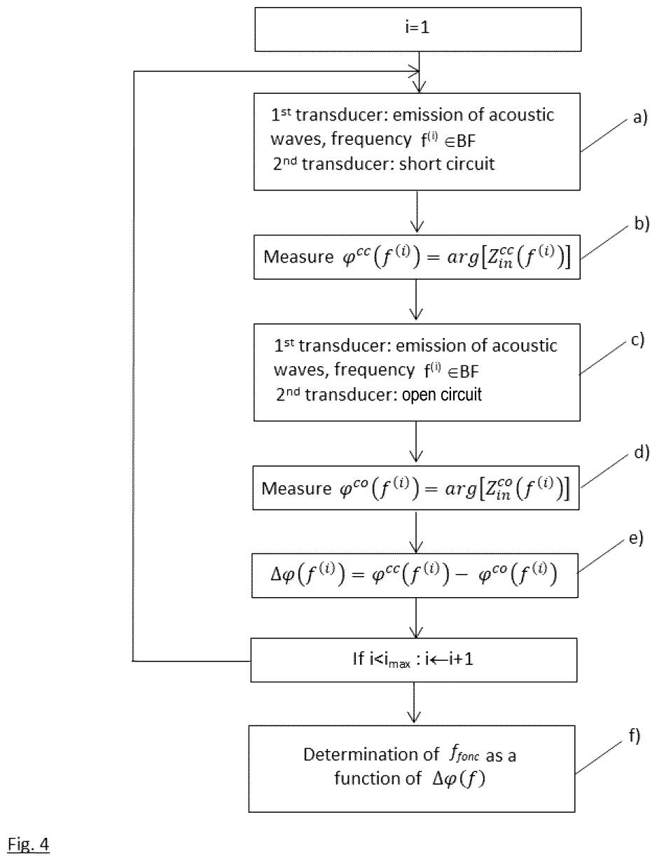

FIG. 4 shows a flowchart of a method for determining an operating frequency of the system SA according to one embodiment of the invention.

Firstly, a plurality of discrete frequencies f⁽ⁱ⁾ sweeping an operating band F are chosen. The index i is first initialized: i=1.

Then—step a)—the first control means MCP controls the first transducer T1 to emit acoustic waves at the frequency f⁽¹⁾ while the second transducer T2 is kept in a short circuit.

During this time—step b), which is in fact simultaneous with step a)—the first control means MCP measures

$${φ}^{sc} ( {f}^{( 1 )} ) = arg [ {Z}_{11}^{sc} ( {f}^{( 1 )} ) ] ,$$

or more exactly calculates φ^{sc}(f⁽¹⁾ from measurements of V₁ and I₁.

Then—step c)—the first control means MCP controls the first transducer T1 to emit acoustic waves at the frequency f⁽¹⁾ while the second transducer T2 is kept in an open circuit.

During this time—step d), which is in fact simultaneous with step c)—the first control means MCP measures

$${φ}^{oc} ( {f}^{( 1 )} ) = arg [ {Z}_{11}^{sc} ( {f}^{( 1 )} ) ] ,$$

or more exactly calculates φ^{oc}(f⁽¹⁾) from measurements of V₁ and I₁.

Then—step e)—the first control means MCP calculates Δφ(f⁽¹⁾)=φ^{sc}(f⁽¹⁾)−φ^{oc}(f⁽¹⁾).

At this point, the index i is incremented and steps a)-e) are iterated until said index reaches its maximum value iₘₐₓ.

In the last step, the operating frequency f_{fonc} is determined from Δφ(f⁽ⁱ⁾) for all the values of i between 1 and iₘₐₓ. As explained above, it will be possible to choose f_{fonc}∈[f₁f₂), preferentially f_{fonc}∈[f₁,f₃], or else f_{fonc}=f₁.

It should be understood that it is possible to reverse the order of steps a/b) and c/d). In addition, it is possible to store the values of φ^{sc}(f⁽ⁱ⁾) and φ^{oc}(f⁽ⁱ⁾) to perform step e) of calculating Δφ(f⁽ⁱ⁾) after having iterated over all the allowable values of i.

It is also possible that steps b) and d) provide the complex values of Zᵢₙ and that, in step e), the complex value ΔZᵢₙ is calculated, then its argument is extracted to obtain Δφ.

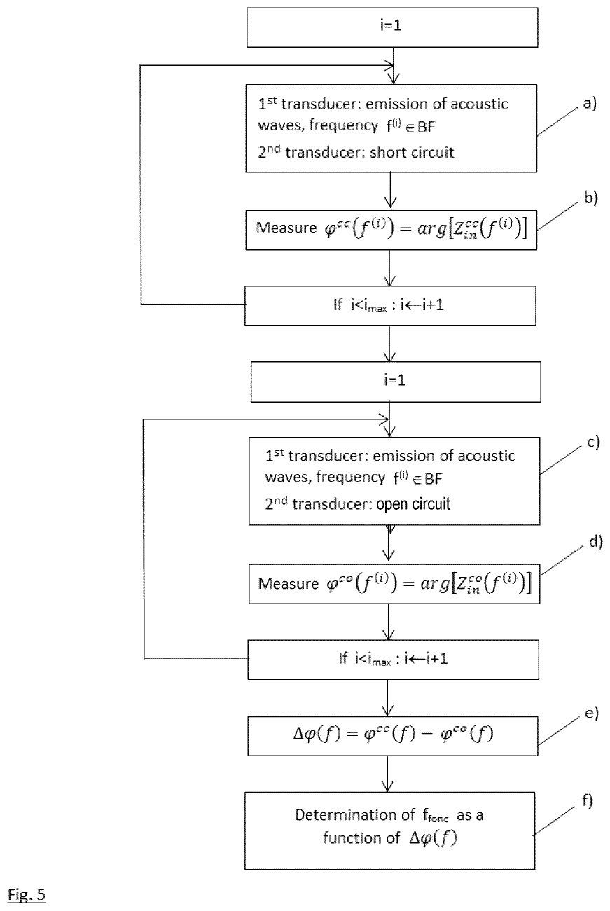

FIG. 5 shows another flowchart of a method for determining an operating frequency of the system SA according to an alternative embodiment of the invention. In this embodiment, steps a) and b) are first carried out iteratively for all allowable values of i, then steps c) and d) are iterated. Steps e) and f) are carried out after the two series of iterations. As in the previous case, it is possible to reverse the order of steps a/b) and c/d). For carrying out this embodiment, it is possible to use signals having a continuous, typically linear, frequency modulation (a “chirp”) to control the transducer T1.

FIG. 6 shows a block diagram of a primary element EP of a system SA according to one embodiment of the invention.

The primary element EP mainly comprises the control means MCP and the transducer MCP. Other components will generally be present: a power supply unit, an input-output interface, etc. These components are generally conventional; hereinbelow, the focus will be on the structure and operation of the control means MCP.

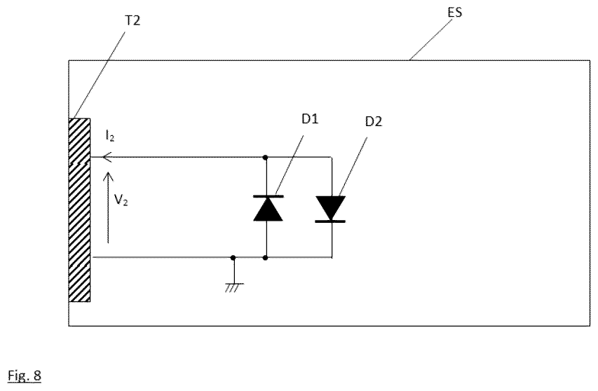

Inside the first control means MCP, a digital processor PROC controls a control circuit CPT, configured to generate an excitation signal for the first transducer T1, to which it is electrically connected. The processor PROC determines the frequency f of said excitation signal and, if need be, its amplitude (the importance of the amplitude will be discussed later, with reference to [FIG. 8]). A first differential amplifier ADV makes it possible to read the voltage V₁ across the terminals of the transducer T1. Its output is digitized by a first analogue-to-digital converter CANV. A second differential amplifier ADI, having two inputs connected to the terminals of a shunt resistor R which is connected in series on the conductor connecting the control circuit CPT to the transducer T1, makes it possible to measure the current I₁ at the input of said transducer. Its output is digitized by a second analogue-to-digital converter CANI. The digital signals at the output of the converters CANV, CANI are supplied to the input of the processor PROC.

The processor PROC may be a microprocessor programmed in an appropriate manner, or else a dedicated digital circuit. In any case, it is configured to, in a first phase:
control the control circuit CPT to perform an operating sweep such that the excitation signal for the transducer T1 successively takes the values f⁽ⁱ⁾ mentioned above;
acquire digital signals of V₁(f⁽ⁱ⁾), I₁(f⁽ⁱ⁾) from the converters CANV, CANI for each of these frequencies;
determine the operating frequency f_{fonc}, as explained above.

And in a second phase:
control the control circuit CPT to emit an acoustic wave OA at the frequency f_{fonc},
acquire digital signals of V₁(f_{fonc}), I₁(f_{fonc}) from the converters CANV, CANI;
determine the phase variations in

$$\frac{{V}_{1}}{{I}_{1}}$$

and deduce therefrom a sequence of bits transmitted, by impedance switching, by the secondary element.

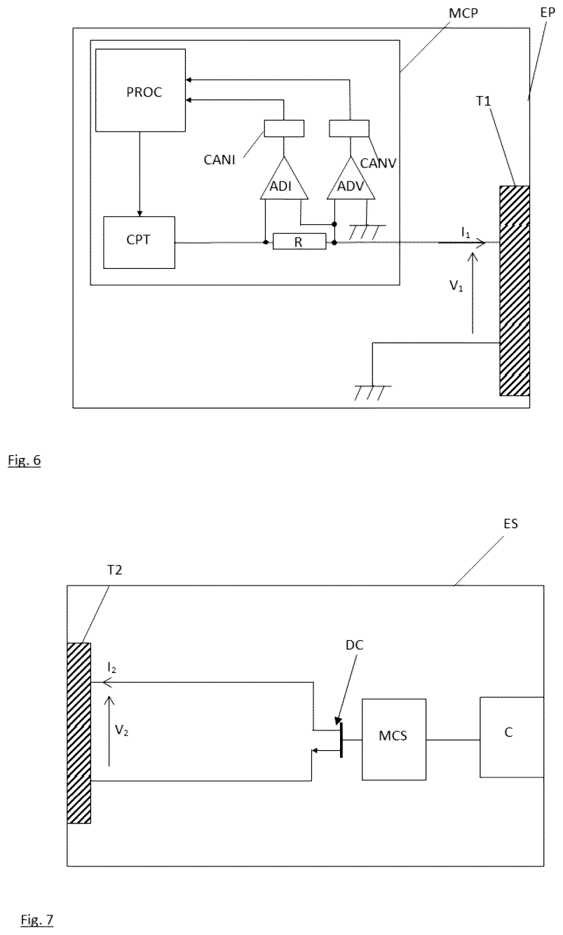

FIG. 7 shows a partial block diagram of a secondary element of a system SA according to one embodiment of the invention.

In this embodiment, the secondary element ES comprises a sensor C which acquires data from the external environment (for example, a temperature) and converts said data into an electrical signal which is supplied to the input of the second control means MCS. The latter controls a switching device DC (in the figure, a MOS transistor) connected to the terminals of the second transducer T2. The information coming from the sensor C is transmitted to the primary element by using the impedance switching technique: when the transistor DC is on, the transducer T2 is in a short circuit; when it is off, it is in an open circuit. The switchovers of the transistor DC are also used to carry out, periodically, a method for determining the operating frequency as described above. In this embodiment, the secondary element plays an active role. It must therefore have been previously supplied with energy by the acoustic waves emitted by the primary element, and be able to receive commands from the latter. The means for energy recovery and storage (rectifier bridge, battery or supercapacitor, etc.) and those for receiving signals (which may be integrated into the second control means MCS) are not shown in the figure because they are conventional.

FIG. 8 illustrates the operating principle of a secondary element which intervenes in a purely passive manner when the method for determining the operating frequency is being carried out. Hence, the operating frequency can be determined even if the secondary element is inactive, or completely discharged. In this embodiment, two diodes D1, D2 connected head-to-tail are connected to the terminals of the transducer T2. When the acoustic waves OA are sufficiently intense, the voltage generated by T2 exceeds the threshold voltage of the diodes, which then behave like short circuits. Conversely, when the intensity of the acoustic waves decreases, the voltage generated by T2 is lower than the threshold voltage of the diodes, which then behave like open circuits. Impedance switching on the secondary element side is therefore controlled by the primary element by controlling the amplitude of the acoustic waves generated by T1.

Even in the embodiment of [FIG. 8], the secondary element generally comprises means for energy recovery and storage (rectifier bridge, battery or supercapacitor, etc.), means for receiving signals, and active means for impedance switching (DC transistor), these means not being shown in the figure, however, because they play no role in the method according to the invention.

### BIBLIOGRAPHY

(Takahashi 2019): V. L. Takahashi et al. “Ultrasonic Power and Data Transfer through Multiple Curved Layers Applied to Pipe Instrumentation” Sensors 2019, 19, 4074

1. A method for determining an operating frequency of an acoustic transmission system (STA) comprising a primary element (EP) and a secondary element (ES), the primary element comprising a first electro-acoustic transducer (TA1) configured to generate acoustic waves (OA) of variable frequency in the direction of the secondary element through a wall (P) and to detect reflections of said acoustic waves by the secondary element, the secondary element (ES) comprising a second electro-acoustic transducer (T2) designed to convert said acoustic waves into an electric supply current, said secondary element being further configured to controllably change an electrical impedance across the terminals of said second transducer between an open-circuit state and a short-circuit state; comprising the following steps:
a) emission of said acoustic waves (OA) from the primary element (EP) to the secondary element (ES), while keeping the second transducer (T2) in a short circuit;
b) simultaneously with step a), measurement of a first phase of the input impedance, on the primary element (EP) side, of an electric quadrupole modelling the assembly formed by the first (T1) and second (T2) acoustically coupled transducers, with the second transducer (T2) in a short circuit;
c) emission of said acoustic waves (OA) from the primary element (EP) to the secondary element (ES), while keeping the second transducer (T2) in an open circuit;
d) simultaneously with step c), measurement of a second phase of the input impedance, on the primary element (EP) side, of an electric quadrupole modelling the assembly formed by the first and second acoustically coupled transducers, with the second transducer (T2) in an open circuit;
e) calculation of the difference (Δφ) between the first and second phases; said steps a) to e) being repeated for a plurality of frequencies sweeping an operating range of the acoustic transmission system; and then
f) determination of said operating frequency as a function of said difference (Δφ) between the first and second phases calculated for said plurality of frequencies.

2. The method according to claim 1, wherein the operating frequency determined in step f) is between a first value (f₁) maximizing said difference between the first and second phases and a second value (f₂) cancelling it, the latter value being excluded.

3. The method according to claim 2, wherein the operating frequency determined in step f) is between said first value (f₁) maximizing said difference between the first and second phases and a third value (f₃) between said first (f₁) and second (f₂) values and such that said difference between the first and second phases assumes a value no less than half its maximum value.

4. The method according to claim 1, comprising, in the secondary element (ES), the actuation of a switching device (DC) to change from a state in which the second transducer (T2) is in a short circuit to a state in which the second transducer (T2) is in an open circuit and vice versa.

5. The method according to claim 1, wherein the secondary element comprises a pair of diodes (D1, D2) connected head-to-tail in parallel with said second transducer, the method comprising the emission, by said primary element, at successive instants, of said acoustic waves (OA) at a first intensity level sufficiently low that a voltage (V2) generated by said second transducer (T2) excited by said acoustic waves (OA) is lower than a voltage of only said diodes (D1, D2), and at a second intensity level sufficiently high that a voltage (V2) generated by said second transducer (T2) excited by said acoustic waves is greater than a voltage of only said diodes.

6. The method according to claim 1, wherein steps a) to e) are carried out successively for each frequency of said plurality of frequencies.

7. The method according to claim 1, wherein steps a) and b) are first carried out for said plurality of frequencies, then steps c) and d) are in turn carried out for the same frequencies, or vice versa.

8. An acoustic transmission system comprising a primary element (EP) and a secondary element (ES), the primary element (EP) comprising a first electro-acoustic transducer (T1) configured to generate acoustic waves (OA) of variable frequency in the direction of the secondary element (ES) through a wall (P) and to detect reflections of said acoustic waves by the secondary element (ES), the secondary element (ES) comprising a second electro-acoustic transducer (T2) designed to convert said acoustic waves into an electric supply current, said secondary element being further configured to controllably change an electrical impedance across the terminals of said second transducer (T2) between an open-circuit state and a short-circuit state; wherein the transmission system comprises a first control means (MCP) configured to control the primary element so as to, for a plurality of frequencies sweeping an operating range of the acoustic transmission system:
a) emit said acoustic waves from the primary element to the secondary element, while keeping the second transducer in a short circuit;
b) simultaneously with step a), measure a first phase of the input impedance, on the primary element side, of an electric quadrupole modelling the assembly formed by the first and second acoustically coupled transducers, with the second transducer in a short circuit;
c) emit said acoustic waves from the primary element to the secondary element, while keeping the second transducer in an open circuit;
d) simultaneously with step c), measure a second phase of the input impedance, on the primary element side, of an electric quadrupole modelling the assembly formed by the first and second acoustically coupled transducers, with the second transducer in an open circuit;
the control means also being configured to
e) calculate the difference between the first and second phases for each frequency of said plurality of frequencies;
and to
f) determine said operating frequency as a function of said difference between the first and second phases calculated for said plurality of frequencies.

9. The system according to claim 8, wherein said control means (MCP) is configured to determine a said operating frequency between a first value (f₁) maximizing said difference between the first and second phases and a second value (f₂) cancelling it, the latter value being excluded.

10. The system according to claim 9, wherein said control means (MCP) is configured to determine a said operating frequency between said first value (f₁) maximizing said difference between the first and second phases and a third value (f₃) between said first (f₁) and second (f₂) values and such that said difference between the first and second phases assumes a value no less than half its maximum value.

11. The system according to claim 8, comprising, in the secondary element (ES), a second control means (MCS) as well as a switching device (DC), said second control means being configured to control the actuation of said switching device so as to cause it to change from a state in which the second transducer (T2) is in a short circuit to a state in which the second transducer is in an open circuit and vice versa (T2).

12. The system according to claim 8, wherein the secondary element comprises a pair of diodes (D1, D2) connected head-to-tail in parallel with said second transducer (T2), said first control means (MCP) also being configured to control the first transducer (T1) so that it emits, at successive instants, said acoustic waves (OA) at a first intensity level sufficiently low that a voltage (V2) generated by said second transducer (T2) excited by said acoustic waves is lower than a voltage of only said diodes (D1, D2), and at a second intensity level sufficiently high that a voltage (V2) generated by said second transducer (T12) excited by said acoustic waves is greater than a voltage of only said diodes (D1, D2).

13. The system according to claim 8, wherein said first control means, or said first and second control means, are configured to carry out steps a) to e) successively for each frequency of said plurality of frequencies.

14. The system according to claim 8, wherein said first control means, or said first and second control means, are configured to first carry out steps a) and b) for said plurality of frequencies, then steps c) and d) for the same frequencies, or vice versa.
